(19) United States
(12) Patent Application Publication
(10) Pub. No.: US 2026/0303542 A1
(43) Pub. Date: Oct. 1, 2026

(54) PER QUEUE PACKET DATA CONVERGENCE PROTOCOL CONFIGURATION

(71) Applicant: QUALCOMM Incorporated, San Diego, CA (US)

(72) Inventors: Sherif Elazzouni, San Diego, CA (US); Sitaramanjaneyulu Kanamarlapudi, San Diego, CA (US); Gavin Bernard Horn, La Jolla, CA (US); Ozcan Ozturk, San Diego, CA (US)

(21) Appl. No.: 19/091,157

(22) Filed: Mar. 26, 2025

(51) Int. Cl. H04L 47/6295; H04L 47/32; H04L 47/33; H04W 8/22

(52) U.S. Cl. CPC H04L 47/6295; H04L 47/32; H04L 47/33; H04W 8/22

(57) ABSTRACT

Techniques related to wireless communication are disclosed. Some aspects of the disclosure relate to a User Equipment (UE) for wireless communication, the UE comprising: one or more computer-readable storage media configured to store a plurality of queues; one or more processors coupled to the one or more computer-readable storage media, the one or more processors configured to cause the UE to: obtain Packet Data Convergence Protocol (PDCP) packets for transmission on a network, wherein the PDCP packets are assigned to a data radio bearer; and assign the PDCP packets to the plurality of queues; and a radio coupled to the processors and configured to transmit the PDCP packets on the data radio bearer according to positions of the PDCP packets in the plurality of queues. Other aspects, embodiments, and features are also claimed and described.

### TECHNICAL FIELD

The technology discussed below relates generally to wireless communication systems.

### BACKGROUND

As the demand for mobile broadband access continues to increase, research and development continue to advance wireless communication technologies not only to meet the growing demand for mobile broadband access, but to advance and enhance the user experience with mobile communications.

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

Typically, Packet Data Convergence Protocol (PDCP) packets are assigned to a data radio bearer (DRB) and transmitted in the order in which the PDCP are enqueued in a queue associated with the DRB. A network entity may use Service Data Adaptation Protocol (SDAP) signaling to specify the flow-to-bearer mapping to the UE. Flows may be marked with a Quality of Service (QoS) flow identifier (QFI) in both downlink (DL) and uplink (UL) packets. Reflective QoS at an access stratum (AS) level (RDI) or Reflective QoS at a Non-Access Stratum (NAS) level (RQI) may be used for applying QoS parameters. A network entity may use RDI or RQI to provide a UE with a mapping from QoS flow to DRBs. The use of SDAP for assignment of flows to DRBs may include the ability to update QoS rules without heavy radio resource control (RRC) or Non-Access Stratum (NAS) signaling overhead, with signaling savings. Additionally, the use of SDAP for assignment of flows to DRBs with QFI headers may allow multiplexing of different QoS flows on the same radio bearer. Furthermore, the use of SDAP for assignment of flows to DRBs may enable QoS-related optimizations, such as reorder, discard, etc. However, in practice UEs were not able to prioritize traffic that is assigned to a DRB. This may lead to problems with congestion in the DRB and dropped packets.

As described herein, a User Equipment (UE) may obtain Packet Data Convergence Protocol (PDCP) packets for transmission on a network. The PDCP packets are assigned to a data radio bearer. The UE may assign the PDCP packets to the plurality of queues. A radio of the UE may be configured to transmit the PDCP packets on the data radio bearer according to positions of the PDCP packets in the plurality of queues. By using the plurality of queues, the UE may be able to prioritize different some types of PDCP packets assigned to the DRB or apply different policies to PDCP packets assigned to the DRB. This may reduce congestion, especially with respect to higher priority PDCP packets.

In one example, this disclosure describes a User Equipment (UE) for wireless communication, the UE comprising: one or more computer-readable storage media configured to store a plurality of queues; a radio; one or more processors coupled to the radio and the one or more computer-readable storage media, the one or more processors configured to cause the UE to: obtain Packet Data Convergence Protocol (PDCP) packets for transmission on a network, wherein the PDCP packets are assigned to a data radio bearer; assign the PDCP packets to the plurality of queues; and transmit, via the radio, the PDCP packets on the data radio bearer according to positions of the PDCP packets in the plurality of queues.

In another example, this disclosure describes a method for wireless communication, the method comprising: storing, by a User Equipment (UE), a plurality of queues; obtaining, by the UE, Packet Data Convergence Protocol (PDCP) packets for transmission on a network, wherein the PDCP packets are assigned to a data radio bearer; assigning, by the UE, the PDCP packets to the plurality of queues; and transmitting, by the UE, the PDCP packets on the data radio bearer according to positions of the PDCP packets in the plurality of queues.

In another example, this disclosure describes a network node comprising: a radio configured to receive PDCP packets from a User Equipment (UE), wherein: the PDCP packets are associated with a first layer of a protocol stack, the PDCP packets include PDCP headers that include queue markers, and the queue markers indicate which queues, of a plurality of queues, to which the UE assigned the PDCP packets for transmission; and one or more processors coupled to the radio, the one or more processors configured to cause the network node to: determine an updated order of the PDCP packets based on the queue markers, wherein the updated order of the PDCP packets is different from an order in which the network node received the PDCP packets; and deliver payloads of the PDCP packets to a second layer of the protocol stack according to the updated order of the PDCP packets.

In another example, this disclosure describes a method for wireless communication, the method comprising: receiving, by a radio of a network node, Packet Data Convergence Protocol (PDCP) packets from a User Equipment (UE), wherein: the PDCP packets are associated with a first layer of a protocol stack, the PDCP packets include PDCP headers that include queue markers, and the queue markers indicate which queues, of a plurality of queues, to which the UE assigned the PDCP packets for transmission; and determining, by one or more processors of the network node, an updated order of the PDCP packets based on the queue markers, wherein the updated order of the PDCP packets is different from an order in which the network node received the PDCP packets; and delivering, by the one or more processors, payloads of the PDCP packets to a second layer of the protocol stack according to the updated order of the PDCP packets.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a schematic illustration of a user plane protocol stack and a control plane protocol stack in accordance with some aspects of this disclosure.

FIG. 3 is a block diagram illustrating an example of a hardware implementation for a network node employing a processing system.

FIG. 4 is a conceptual diagram illustrating example queues in accordance with one or more techniques of this disclosure.

FIG. 5 is a flow chart illustrating an exemplary process of a User Equipment (UE) for wireless communication in accordance with some aspects of the present disclosure.

FIG. 6 is a flow chart illustrating an exemplary process of a network node for wireless communication in accordance with some aspects of the present disclosure.

### DETAILED DESCRIPTION

In fifth-generation wireless communication systems (5G), a User Equipment (UE) may be configured with up to sixteen data radio bearers (DRBs) that can carry different types of traffic. Each of the DRBs configured at the UE may be associated with a queue. Packet Data Convergence Protocol (PDCP) packets assigned to a DRB are enqueued in the queue associated with the DRB and transmitted in the order in which the PDCP packets are enqueued in the queue associated with the DRB. However, in practice, network operators only configure UEs with two DRBs, one for data and one for voice. Since diverse traffic sessions are typically carried on the same DRB, the 5G specification mandates that each packet in the DRB receives exactly the same treatment in the Access Stratum (AS), with two exceptions. Specifically, after Logical Channel (LCH) prioritization to determine how a grant would be filled with bytes access logical channels, the UE has freedom over how to fill the portion of the grant allocated to each LCH. Additionally, Release-18 of the 5G specification allowed UEs to discard low-importance traffic in the event of congestion. However, all other AS-related actions, such as discarding, buffer reporting, and inter-LCH prioritization, operate on the bearer level and thus must be applied to all types of traffic equally. In practice, this framework does not work well, which may lead to a different implementation framework that categorizes traffic and treats it differently, since in practice only one data bearer is usually configured and treating all packets of the same bearer the same leads to performance degradation.

Previous attempts to address this problem have had unsatisfactory results. For example, creating an admission control mechanism where packets can be accepted or rejected based on available memory was proposed in which PDCP packets were marked with priority indicators. In times when a DRB is congested, the UE may review the priority indicators of PDCP packets at the tail of the queue associated with the DRB and selectively drop PDCP packets. Alternatively, the UE may prevent PDCP packets marked as having lower priority from being enqueued in the queue. Thus, the PDCP packets marked as having higher priority are not dropped but rather may be allowed to remain in the queue or be enqueued in the queue. However, in such techniques where every packet in a DRB gets the same treatment, it may be necessary to set up different bidirectional DRBs in order to provide for different treatment among packets. However, setting up different bidirectional DRBs to provide for different treatment among packets may increase memory, processing, and cost requirements.

This disclosure describes techniques that may address such problems. As described herein, a UE may obtain Packet Data Convergence Protocol (PDCP) packets for transmission on a network. The PDCP packets are assigned to a data radio bearer. The UE may assign the PDCP packets to the plurality of queues. A radio of the UE may be configured to transmit the PDCP packets on the data radio bearer according to positions of the PDCP packets in the plurality of queues. In some examples, the PDCP packets include low-latency PDCP packets, high-priority PDCP packets, and normal priority PDCP packets. In general, low-latency PDCP packets need to be delivered within a tight delay budget, such as 10-20 milliseconds (ms). In general, high-priority PDCP packets are more important than other PDCP packets in a flow, such as Transmission Control Protocol (TCP) SYN or TCP ACK packets. The UE may assign the low-latency PDCP packets to a first queue of the plurality of queues, assign the high-priority PDCP packets to a second queue of the plurality of queues, and assign the normal priority PDCP packets to a third queue of the plurality of queues. By using the plurality of queues, the UE may be able to prioritize different some types of PDCP packets assigned to the DRB or apply different policies to PDCP packets assigned to the DRB. This may reduce congestion, especially with respect to higher priority PDCP packets.

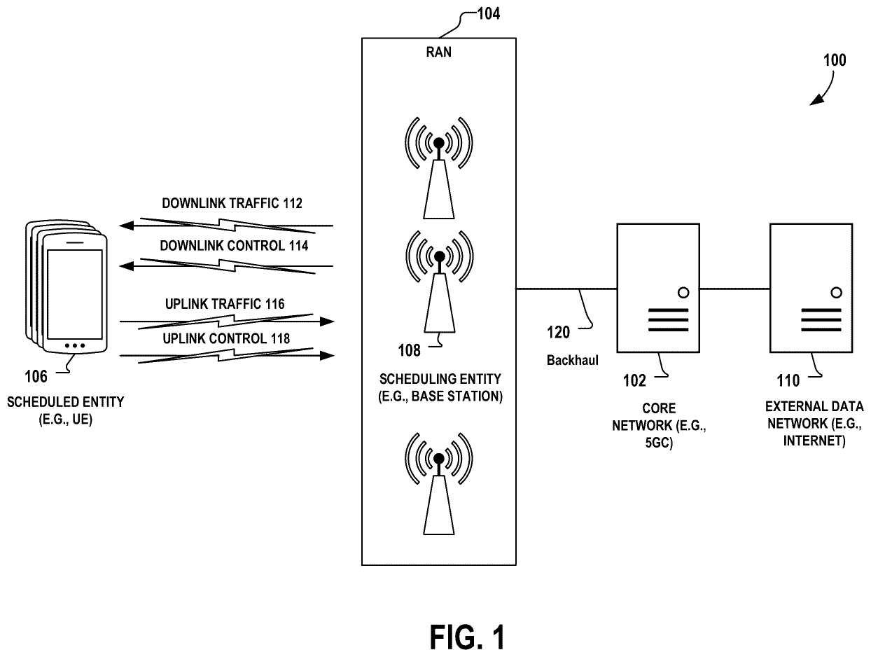

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, UE 106 may be enabled to carry out data communication with an external data network 110, such as (but not limited to) the Internet.

RAN 104 may implement any suitable wireless communication technology or technologies to provide radio access to UE 106. As one example, RAN 104 may operate according to 3rd Generation Partnership Project (3GPP) New Radio (NR) specifications, often referred to as 5G or 5G NR. In some examples, RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, RAN 104 includes a plurality of network nodes 108. Broadly, a network node is a network element in a radio access network responsible for radio transmission and reception in one or more cells to or from a UE. In different technologies, standards, or contexts, those skilled in the art may variously refer to a “network node” as a base station, a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), or some other suitable terminology.

RAN 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus, such as a UE, need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between RAN 104 and UE 106 may be described as utilizing an air interface. Transmissions over the air interface from a base station (e.g., network node 108) to one or more UEs (e.g., UE 106) may be referred to as downlink (DL) transmission. In accordance with certain aspects of the present disclosure, the term downlink may refer to a point-to-multipoint transmission originating at a scheduling entity, such as network node 108. Another way to describe this scheme may be to use the term broadcast channel multiplexing. Transmissions from a UE (e.g., UE 106) to a base station (e.g., network node 108) may be referred to as uplink (UL) transmissions. In accordance with further aspects of the present disclosure, the term uplink may refer to a point-to-point transmission originating at a scheduled entity, such as UE 106.

In some examples, access to the air interface may be scheduled, wherein a scheduling entity (e.g., network node 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs, which may be scheduled entities, may utilize resources allocated by a scheduling entity, such as one of network nodes 108.

Network nodes and base stations are not the only entities that may function as scheduling entities. That is, in some examples, a UE or network node may function as a scheduling entity, scheduling resources for one or more scheduled entities (e.g., one or more UEs).

As illustrated in FIG. 1, network node 108 may broadcast downlink traffic 112 to one or more UEs 106. Broadly, network node 108 is a node or device responsible for scheduling traffic in a wireless communication network, including downlink traffic 112 and, in some examples, uplink traffic 116 from one or more UEs 106 to the network node 108. On the other hand, UE 106 is a node or device that receives downlink control information 114, including but not limited to scheduling information (e.g., a grant), synchronization or timing information, or other control information from another entity in the wireless communication network such as network node 108. In some examples, UE 106 may transmit uplink control traffic 118 to network node 108.

In general, network nodes, such as network node 108, may include a backhaul interface for communication with a backhaul network 120 of the wireless communication system. Backhaul network 120 may provide a link between network node 108 and core network 102. Further, in some examples, backhaul network 120 may provide interconnection between the respective network nodes 108. Various types of backhaul interfaces may be employed, such as a direct physical connection, a virtual network, or the like using any suitable transport network.

Core network 102 may be a part of wireless communication system 100 and may be independent of the radio access technology used in RAN 104. In some examples, core network 102 may be configured according to 5G standards (e.g., 5GC). In other examples, core network 102 may be configured according to a 4G evolved packet core (EPC), or any other suitable standard or configuration.

In general, the 5G specification requires all PDCP packets assigned to the same DRB to receive the same treatment in the AS. However, this requirement may lead to problems, especially with respect to PDCP packets carrying higher-priority data, such as low-latency (LLM) traffic, PDCP packets carrying Transmission Control Protocol (TCP) acknowledgments, and PDCP packets carrying other types of high-priority data. For instance, at times when the DRB is congested, the PDCP packets carrying higher-priority data may be delayed or discarded in the same way as PDCP packets carrying lower-priority data.

This disclosure describes techniques that may address these issues. As described herein, UE 106 may obtain PDCP packets for transmission on a network. Obtaining the PDCP packets may include UE 106 generating the PDCP packets or receiving the PDCP UE 106 may transmit the PDCP packets as part of uplink traffic 116 or uplink control traffic 118. The PDCP packets are assigned to a data radio bearer configured on UE 106. UE 106 may assign the PDCP packets to the plurality of queues. For example, the PDCP packets include low-latency PDCP packets, high-priority PDCP packets, and normal priority PDCP packets. UE 106 may assign the low-latency PDCP packets to a first queue of the plurality of queues, assign the high-priority PDCP packets to a second queue of the plurality of queues, and assign the normal priority PDCP packets to a third queue of the plurality of queues. UE 106 may transmit the PDCP packets on the data radio bearer according to positions of the PDCP packets in the plurality of queues. In other words, UE 106 may transmit PDCP packets from the heads of the queues. In some examples, UE 106 may implement different discard policies for different queues of the plurality of queues. Utilizing a plurality of queues for PDCP packets that are all assigned to the same DRB may increase the ability of UE 106 to ensure transmission of PDCP packets that carry higher-priority data.

The techniques of this disclosure may provide several advantages relative to the 5G specification. For example, the techniques of this disclosure may avoid the need to configure UEs with multiple DRBs in order to handle traffic differently. Rather, the techniques of this disclosure allow a UE to handle traffic differently within a single DRB. In another example, the 5G specification is only able to provide traffic granularity at an Internet Protocol (IP) flow level (e.g., using service data flows (SDF) or 5G QoS identifiers). Thus, in the 5G specification, there is no ability to isolate TCP acknowledgments. However, the techniques of this disclosure may allow for arbitrary granularity. For instance, UE 106 may use a proprietary mechanism for identifying traffic, and therefore may be able to isolate TCP acknowledgement and treat them differently. This may enable UE 106 to allow high priority traffic to bypass LCH restrictions.

In another example, in the 5G specification, power, memory, and signaling overhead may scale with the number of DRBs needed to transmit the QoS flows (i.e., flows having their own QoS requirements). In contrast, with the techniques of this disclosure, only a single DRB may be needed. Network overhead requirements may also be higher in the 5G specification because the network may need to exchange information with core network 102 to determine QoS requirements of each flow and continuously remap flows to DRBs. This has proven to be impractical and does not currently happen in practice. The techniques of this disclosure may use an existing internal mechanism to identify traffic (e.g., PDCP packets) and locally map the traffic to queues. Furthermore, in the 5G specification, DRBs must be bidirectional and encapsulate all traffic of a flow. In accordance with techniques of this disclosure, queues may be unidirectional as a baseline. The queues may be made bidirectional by packet marking. In other words, as a baseline, queues are uplink only and the receiver (e.g., a gNB) in this case does not necessarily track which packet came from which queue. However, if we introduce reordering optimizations, the receiver would also need to know which queue that packet came from so that the receiver can reorder packets accordingly (per queue).

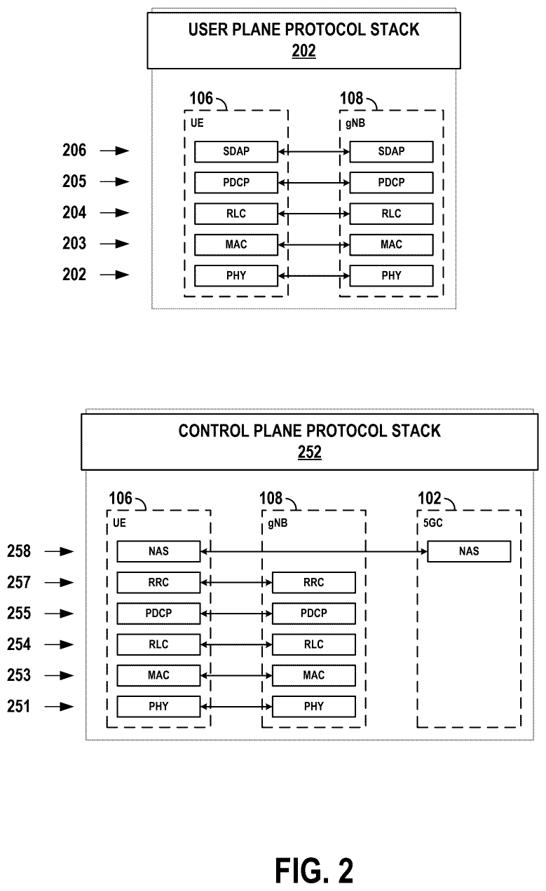

FIG. 2 is a schematic illustration of a user plane protocol stack 202 and a control plane protocol stack 252 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS protocol layer 258) and Access Stratum (AS, 202-206 and 251-257) layers and protocols. NAS protocol layer 258 provides upper layers, for signaling between a UE 106 and a core network 102 (referring to FIG. 1). AS protocols 202-206 and 252-257 provides lower layers, for signaling between RAN 104 (e.g., a gNB or other network node 108) and the UE 106.

Turning to FIG. 2, a radio protocol architecture is illustrated with a user plane protocol stack 202 and a control plane protocol stack 252, showing their respective layers or sublayers. Radio bearers between a network node 108 and a UE 106 may be categorized as data radio bearers (DRB) for carrying user plane data, corresponding to the user plane protocol stack 202; and signaling radio bearers (SRB) for carrying control plane data, corresponding to the control plane protocol stack 252.

In the AS, both the user plane protocol stack 202 and control plane protocol stack 252 include a physical layer (PHY) 202/251, a medium access control layer (MAC) 203/253, a radio link control layer (RLC) 204/254, and a packet data convergence protocol layer (PDCP) 205/255. PHY 202/251 is the lowest layer and implements various physical layer signal processing functions. MAC layer 203/253 provides multiplexing between logical and transport channels and is responsible for various functions. For example, MAC layer 203/253 is responsible for reporting scheduling information, priority handling and prioritization, and error correction through hybrid automatic repeat request (HARQ) operations. RLC layer 204/254 provides functions such as sequence numbering, segmentation and reassembly of upper layer data packets, and duplicate packet detection. PDCP layer 205/255 provides functions including header compression for upper layer data packets to reduce radio transmission overhead, security by ciphering the data packets, and integrity protection and verification.

In user plane protocol stack 202, a service data adaptation protocol (SDAP) layer 206 provides services and functions for maintaining a desired quality of service (QoS). And in control plane protocol stack 252, a radio resource control (RRC) layer 257 includes a number of functional entities for routing higher layer messages, handling broadcasting and paging functions, establishing and configuring radio bearers, NAS message transfer between NAS and UE, etc.

A NAS protocol layer 258 provides for a wide variety of control functions between UE 106 and core network 102. These functions include, for example, registration management functionality, connection management functionality, and user plane connection activation and deactivation.

In user plane protocol stack 202, SDAP layer 206 provides services and functions for maintaining a desired quality of service (QoS), including mapping between a QoS flow and a sidelink data radio bearer. QoS broadly refers to the collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service.

And in control plane protocol stack 252, a radio resource control (RRC) layer 257 includes a number of functional entities for transferring RRC messages between paired UEs, for maintenance and release of an RRC connection between UEs, and for detection of a sidelink radio link failure.

In some examples, a physical layer may generally multiplex and map these physical channels described above to transport channels for handling at a MAC layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

Some modern wireless networks, such as a 5G NR network, may provide radio resources over a very wide frequency range. However, any given UE accessing a cell may have bandwidth capabilities that do not span this entire range. Accordingly, a RAN may configure a part or a portion of a carrier for that UE, called a bandwidth part (BWP), which has a bandwidth less than or equal to that UE's capabilities. A RAN may configure a UE with several BWPs (in some examples, up to four BWPs); although typically only a single BWP at a time is an active BWP. In this disclosure, a BWP refers to a set of wireless resources (e.g., a contiguous set of PRBs) selected as a subset of the wireless resources on a given carrier. In some examples, a BWP may be selected from among a contiguous set of resource blocks that share a common numerology (e.g., subcarrier spacing) on a given carrier. The RAN generally does not expect a UE to communicate outside an active BWP.

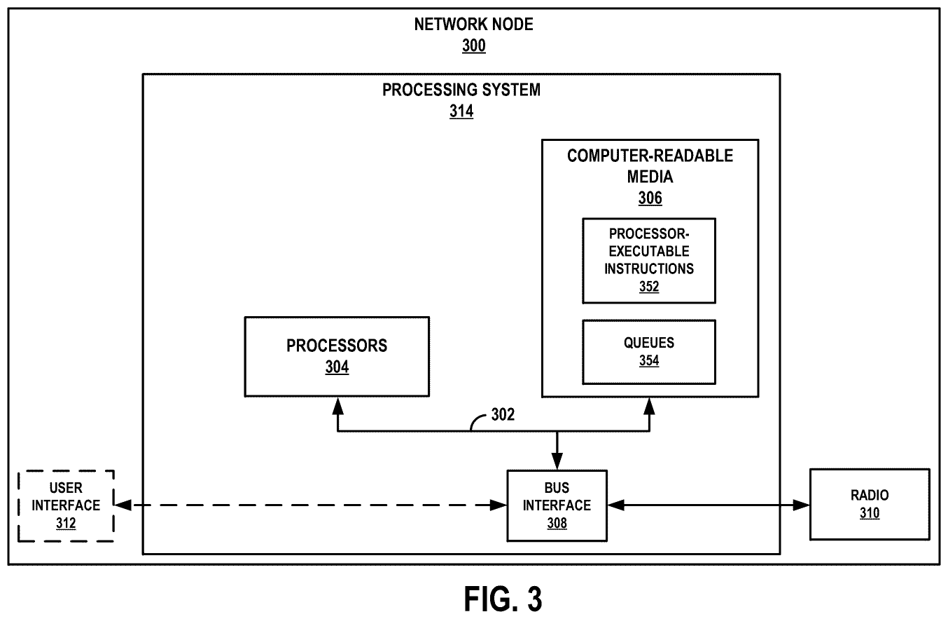

FIG. 3 is a block diagram illustrating an example of a hardware implementation for a network node 300 employing a processing system 314. For example, network node 300 may be a user equipment (UE) as illustrated in FIG. 1. In another example, network node 300 may be a network entity, such as network node 108 (e.g., a base station, scheduling entity, etc.), as illustrated in FIG. 1.

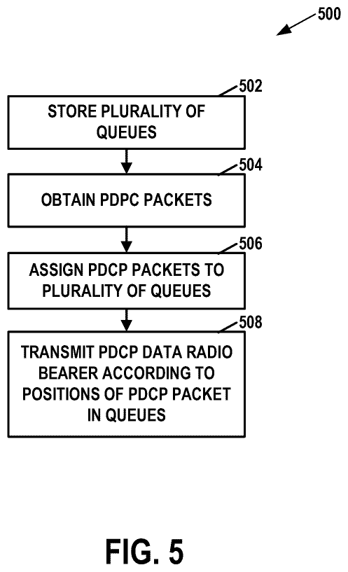

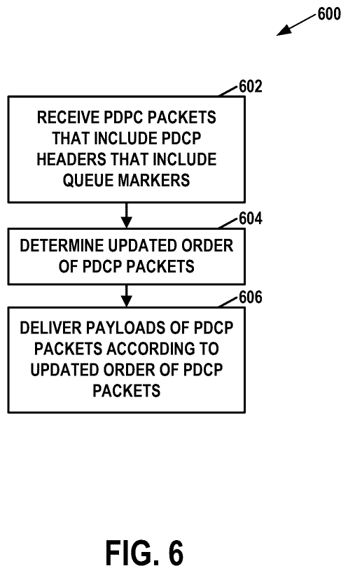

Network node 300 may include a processing system 314 having one or more processors 304. Examples of processors 304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, network node 300 may be configured to perform any one or more of the functions described herein. For example, processors 304, as utilized in network node 300, may be configured (e.g., in coordination with one or more memories, such as computer-readable storage media 306) to implement any one or more of the processes and procedures described below and illustrated in FIG. 5, FIG. 6, and elsewhere in this disclosure.

Processing system 314 may be implemented with a bus architecture, represented generally by a bus 302. Bus 302 may include any number of interconnecting buses and bridges depending on the specific application of processing system 314 and the overall design constraints. Bus 302 communicatively couples together various circuits including one or more processors (represented generally by processors 304), and one or more computer-readable media (represented generally by computer-readable storage media 306). Bus 302 may also link various other circuits such as timing sources, peripherals, voltage regulators, and power management circuits, which are well known in the art, and therefore, will not be described any further. A bus interface 308 provides an interface between bus 302 and a radio 310. Radio 310 provides a communication interface or means for communicating with various other apparatus over a transmission medium. Depending upon the nature of the apparatus, a user interface 312 (e.g., keypad, display, speaker, microphone, joystick) may also be provided. User interface 312 may be optional, and some examples, such as examples where network node 300 is a base station, may omit user interface 312.

Processors 304 may be responsible for managing bus 302 and general processing, including the execution of software stored on computer-readable storage media 306. The software, when executed by processors 304, causes processing system 314 to perform the various functions described below for any particular apparatus. Processors 304 may also use computer-readable storage media 306 for storing data that processors 304 manipulate when executing software.

Processors 304 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on computer-readable storage media 306. Computer-readable storage media 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, cache memory, a removable disk, and any other suitable medium for storing software, instructions, or data that may be accessed and read by a computer. Computer-readable storage media 306 may reside in processing system 314, external to processing system 314, or distributed across multiple entities including processing system 314. Computer-readable storage media 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, computer-readable storage media 306 may store computer-executable code that includes processor-executable instructions 352 that configure network node 300 for various functions, including, e.g., obtaining PDCP packets for transmission on a network (where the PDCP packets are assigned to a data radio bearer); and assigning the PDCP packets to the plurality of queues 354. Queues 354 may be data structures stored in computer-readable storage media 306 (e.g., RAM, registers, etc.).

In an example where network node 300 is a UE, network node 300 includes means for storing a plurality of queues (e.g., computer-readable storage media 306), means for obtaining Packet Data Convergence Protocol (PDCP) packets for transmission on a network (e.g., processors 304), wherein the PDCP packets are assigned to a data radio bearer; and means for assigning the PDCP packets to the plurality of queues (e.g., processors 304); and means for transmitting the PDCP packets on the data radio bearer according to positions of the PDCP packets in the plurality of queues (e.g., radio 310).

In some examples where apparatus is a network entity such as network node 108, computer-readable storage media 306 may store computer-executable code that includes processor-executable instructions 352 cause network node 300 to receive PDCP packets from a User Equipment (UE), wherein: the PDCP packets are associated with a first layer of a protocol stack, the PDCP packets include PDCP headers that include queue markers, and the queue markers indicate which queues, of a plurality of queues, to which the UE assigned the PDCP packets for transmission; and determine an updated order of the PDCP packets based on the queue markers, wherein the updated order of the PDCP packets is different from an order in which the network entity received the PDCP packets; and deliver payloads of the PDCP packets to a second layer of the protocol stack according to the updated order of the PDCP packets.

In an example where network node 300 is a network entity such as network node 108, network node 300 may include means for storing (e.g., computer-readable storage media 306) computer-executable code that includes processor-executable instructions 352 that cause network node 300 to receive PDCP packets from a User Equipment (UE), wherein: the PDCP packets are associated with a first layer of a protocol stack, the PDCP packets include PDCP headers that include queue markers, and the queue markers indicate which queues, of a plurality of queues, to which the UE assigned the PDCP packets for transmission; and means for (e.g., processors 304) for determining an updated order of the PDCP packets based on the queue markers, wherein the updated order of the PDCP packets is different from an order in which the network entity received the PDCP packets; and means for delivering (e.g., processors 304) at least payloads of the PDCP packets to a second layer of the protocol stack according to the updated order of the PDCP packets.

In the above examples, the circuitry included in processors 304 is merely provided as an example, and other means for carrying out the described functions may be included within various aspects of the present disclosure, including but not limited to the instructions stored in computer-readable storage media 306, or any other suitable apparatus or means described in FIG. 1, and utilizing, for example, the processes and/or algorithms described herein in relation to FIG. 5, FIG. 6, and elsewhere in this disclosure.

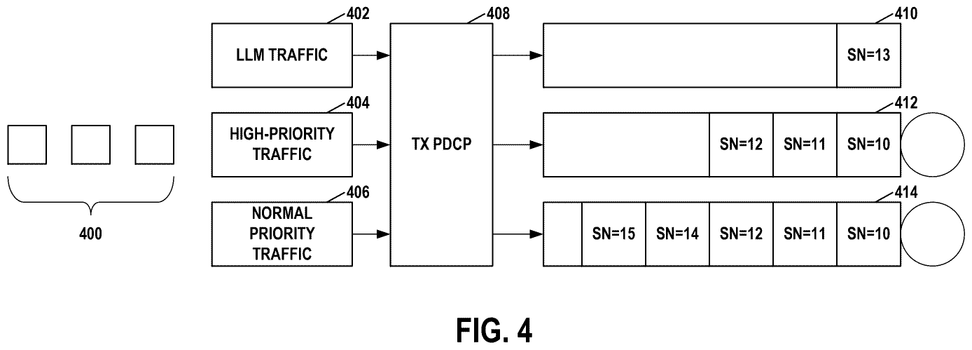

FIG. 4 is a conceptual diagram illustrating example queues in accordance with one or more techniques of this disclosure. In the example of FIG. 4, UE 106 may obtain a series of PDCP packets 400. A transmitting PDCP unit 408 (TX PDCP) of UE 106 may classify individual ones of PDCP packets 400 into a plurality of categories. The plurality of categories may include LLM traffic 402, high-priority traffic 404, and normal priority traffic 406. UE 106 may enqueue PDCP packets 400 in a queue corresponding to the categories into which PDCP packets 400 are classified. Thus, LLM traffic 402 may be enqueue in an LLM queue 410, high-priority traffic 404 may be enqueued in a high-priority queue 412, and normal priority traffic 406 may be enqueued in normal priority queue 414.

In other examples, there may be different numbers of categories and queues. In some examples, the quantity of queues does not exceed a quantity required for traffic identification. In other words, the quantity of the queues is not greater than the number of different types of identified traffic.

In some examples, UE 106 may determine, on its own, how to assign PDCP packets 400 to queues. In some examples, a wireless communication specification, such as the emerging 6G specification, may at least partially specify how to assign PDCP packets 400 to the queues. For instance, the wireless communication specification may specify that PDCP packets containing Layer 4 traffic (e.g., TCP acknowledgments) are allowed to use high-priority queue 412. In some examples, UE 106 may receive, from the network, configuration data indicating types of traffic to assign to different queues in the plurality of queues. Example types of traffic may include TCP data/TCP ACK/TCP SYN (same for other protocols e.g. QUIC, WebRTC, RTP), Video I, B, P frames, RTP voice packets. RTP silent packets, Data or Parity streams in an encoded flow, etc. High/Low Importance PDU set. In some examples, the assignment of PDCP packets to queues may be specified at least in part by one or more network entities as part of a QoS configuration. In other words, a network entity may configure a QoS flow-to-queue mapping or an arbitrary traffic classification-to-queue mapping. In some examples, the network entity may configure a traffic classification to define a packet treatment in the access strum (AS) without the queue framework. For example, the network entity may configure the traffic classification mechanism and subsequent packet treatment in terms of marking, discarding, etc. without physical queues being mandated.

In some examples, UE 106 may implement different queue management policies for different queues. For instance, in some such examples, the queue management policies may include discard policies. The discard policies for the queues may specify discard timers for the queues. UE 106 may remove a PDCP packet from the queue if the PDCP packet has remained in the queue for a longer duration that a duration specified by the discard timer for the queue. In some examples, a network entity may signal the discard timer for a queue to UE 106 based on congestion levels. For instance, the network entity may signal a shorter discard timer to UE 106 if there are higher congestion levels. This may be a special case of Protocol Data Unit (PDU) Set Important (PSI) discard. A PDU Set is a construct for extended reality (XR) communication.

In some examples, one or more of the queue management policies include one or more criteria for Explicit Congestion Notification (ECN) marking. ECN is a network feature that allows end-to-end notification of network congestion without dropping packets. ECN is an extension to the Internet Protocol (IP) and Transmission Control Protocol (TCP). ECN marks packets to indicate congestion instead of dropping them. This helps in managing network congestion more efficiently. The receiver of an ECN-marked packet echoes the congestion indication back to the sender, which then reduces its transmission rate to alleviate congestion. ECN may require support from both the network infrastructure and the endpoints (sender and receiver) to function correctly. In IP, ECN uses two bits in the IP header to encode four different code points, indicating whether the packet is ECN-capable and whether congestion has been experienced. In TCP, the congestion indication is echoed back by setting specific bits in the TCP header. Other queue management policies may relate to sending information to the network (e.g., UE assistance information (UAI), burst information, data rate recommendation, etc.), and feedback to the application.

In accordance with one or more techniques of this disclosure, low-latency queues may need more aggressive marking than normal queues because low-latency applications typically avoid filling their queues more than TCP (which typically attempts to keep queues full to provide high link utilization). Thus, based on a latency of the low-latency PDCP packets being greater than a first latency threshold, UE 106 may mark low-latency PDCP packets with ECN data points. Based on a latency of the normal priority PDCP packets being greater than a second latency threshold, UE 106 may mark the normal priority PDCP packets with the ECN data points, wherein the first latency threshold is lower than the second latency threshold.

In some examples, UE 106 transmits queue-related information to one or more network entities or application is per queue or per QoS flow. In other words, queues 354 may carry multiple QoS flows, thus UE 106 can report queue information and/or report individual information about individual QoS flows.

A DRB or logical channel may take actions with respect to buffer status reporting (BSR) and delay status reporting (DSR). BSR in 5G is a mechanism used by a UE to inform a network entity (e.g., a base station, such as a gNodeB) about the amount of data the UE has in its buffer waiting to be transmitted. DSR in 5G is a mechanism that allows a UE to report the delay status of data packets to a network entity, such as a base station (e.g., gNodeB).

In 5G, BSR and DSR are configured via a logical channel group configuration based on a logical channel (LCH) configuration. In other words, parameters controlling BSR and DSR are part of the configuration information of an LCH. In a baseline 5G implementation, the PDCP configuration information for a DRB includes the configuration information for one LCH. However, for low-latency queues, it may be useful to perform BSR and DSR separately to allow the network to prioritize scheduling grants for PDCP packets in the low-latency queues. For normal-priority traffic, DSR may not be needed. To address this, multiple LCHs may be configured for a DRB with one LCH per queue. In other words, separate LCHs may be configured for each of the queues. However, configuring one LCH per queue may be complex because each of the queues may need its own bucket size duration, prioritization bit rate, allowed cells/resources, and logical channel group data containing BSR and DSR configuration parameters. Configuring one LCH per queue may also introduce more complexity into transport block building.

In accordance with a technique of this disclosure, separate configuration information may be provided for individual queues. The configuration information for a queue may include parameters related to BSR and DSR. Providing limited configuration information for queues may avoid incurring the complexity of multiple logical channels per DRB. The parameters included in the configuration information for a queue may include parameters used by UE 106 based on implementation for internal queue management. Example parameters that may be included in the configuration information for a queue may include one or more of a discard timer, priority, logical channel group, BSR configuration, DSR configuration, and scheduling request (SR) identifier. Thus, in such examples, the PDCP configuration information for a DRB may include a sequence number (SN) size (e.g., 12 bits, 18 bits, etc.), a T-reordering data, dual connectivity data, a SN gap report, uplink data compression (UDC) data, Ethernet header compression (EHC) data, Robust Header Compression (RHC) data, and other data, but exclude a discard timer and a low-importance discard timer. In general, a SN is a counter for packets arriving from UEs. Furthermore, in such examples, the LCH configuration information may include a prioritized bit rate, a bucket size duration, allowed cells/resources data, and so on, but exclude priority, logical channel group data, BSR configuration data, and DSR configuration data. In this way, there may be one set of PDCP configuration information for a DRB, two or more sets of queue configuration information for the DRB, and one set of LCH configuration information for the DRB. In some examples, parameters that are not configured on a per-queue basis apply the PDCP configuration. In other words, if a parameter is not included in the queue configuration information, UE 106 may use a value of the parameter specified by the PDCP configuration information.

UE 106 may receive the queue configuration information from a network entity, such as network node 108. In some examples, the queue configuration information may originate at UE 106. In examples where the queue configuration information originates at UE 106, UE 106 may transmit the queue configuration information to one or more network entities, such as network node 108.

UE 106 may manage queues 354 in accordance with the queue configuration information. For instance, UE 106 may perform BSR or DSR with respect to PDCP packets in the queue, as specified in the BSR and DSR configuration parameters in the queue configuration information. Thus, in some examples, UE 106 may implement, for each queue of the plurality of queues, a queue management process for the queue. The queue management process for the queue may manage one or more of: a discard timer for the queue, a prioritization of PDCP packets in the queue, reporting of one or more of buffer status reporting or delay status reporting associated with the queue, and a scheduling request identifier (SR ID) associated with the queue. The queue management process may be a process, threads, or other way of computerized management of a queue.

In some examples, some MAC/RLC parameter configurations may be moved to queue configuration information. Thus, a queue management process for the queue manages one or more of: (i) one or more Media Access Control (MAC) parameters or (ii) one or more Radio Link Control parameters. In other words, RLC and/or MAC behavior may be mapped to specific queues. Examples of MAC parameters may include bucket size, logical channel prioritization (LCP), prioritized bit rate, and so on. The bucket size may refer to an amount of data that can be transmitted or received within a specific period. The bucket size determines the maximum amount of data that can be sent or received before the network needs to take action, such as throttling the data rate or applying other traffic management techniques. Examples of RLC parameters may include polling criteria (e.g., bytes, protocol data unit (PDU) counts, and timers), and status prohibit timers. A status prohibit timer is a mechanism used in the Radio Link Control (RLC) protocol, specifically in the Acknowledged Mode (AM). This timer is used to control the frequency of status reports sent by the receiver to the transmitter. When the status prohibit timer is running, the receiver is prohibited from sending status reports, even if there are updates to be sent. This helps to reduce the overhead and avoid excessive signaling.

In some examples, UE 106 communicates the number and/or type of queues supported per DRB during a capability exchange. In other words, UE 106 and a network entity may exchange capability information. The capability information sent by UE 106 may indicate capabilities of UE 106 and the capability information sent by the network entity may indicate capabilities of the network entity. Thus, in such examples, UE 106 may communicate to the network entity capability information indicating a quantity of queues that UE 106 is configured to support for each DRB. UE 106 may communicate to the network entity capability information indicating types of queues supported for DRB. In some examples, UE 106 may communicate, to the network entity, queue state information, such as a quantity of packets in each of the queues or how long the packets have been in the queues.

In some examples, UE 106 may receive, from a network entity, queue configuration data. The queue configuration data is based on the UE capability data (i.e., capability information sent by UE 106). UE 106 may configure the queues based on the queue configuration data. For instance, the queue configuration data may specify a quantity of queues to use for a DRB.

In some examples, to simplify deployment, queue configuration is an uplink-only feature to be implemented at UE 106 based on a traffic classification scheme of UE 106. Furthermore, in some examples, UE 106 may mark headers of PDCP packets in order to enable a receiver of the PDCP packets to perform in-order processing or out-of-order processing. For instance, UE 106 may add a QoS Flow identifier (QFI) in the headers of the PDCP packets. The QFIs may identify QoS flows of the PDCP packets. Including the QFIs may increase the size of the headers by 6 bits, which may require a new byte or SDAP to be included in the headers. For instance, in a first example, a SDAP header (1 byte) may be used to identify QoS flows. In a second example, a queue marker may be used to identify QoS flows, where the queue marker is more coarse but less complex than the first example. In a third example, a single bit may be used to process a packet in or out of order. One advantage of the second and third examples, other than efficiency of signaling and low complexity at the receiver, is that more useful ways to perform reordering optimizations can be chosen, e.g., by indicating that the packet carries a TCP Ack which is very latency sensitive. This may be not available in the first example since TCP data and ACKs come from same QoS flow, but the use of queues, as described in this disclosure, may enable reordering.

In some examples, UE 106 may add a queue marker to headers of the PDCP packets to aid receiving optimizations. The queue markers indicate which of the queues the PDCP packets were assigned to. In some examples where the number of queues per DRB is relatively small (e.g., 3 queues per DRB), only a small number of bits may be needed for the queue marker. In some examples, reserved bits of the headers of PDCP packets are used for the queue markers. In some examples, a new SDAP header is used to specify the queue marker. Thus, network node 108 may receive PDCP packets from UE 106. The PDCP packets include PDCP headers that include queue markers. The queue markers indicate which queues, of a plurality of queues, to which the UE assigned the PDCP packets for transmission. Network node 108 may determine an updated order of the PDCP packets based on the queue markers. The updated order of the PDCP packets is different from an order in which the network entity received the PDCP packets. Network node 108 may deliver payloads of the PDCP packets to a second layer of the protocol stack according to the updated order of the PDCP packets.

FIG. 5 is a flow chart illustrating an exemplary process 500 of UE 106 for wireless communication in accordance with some aspects of the present disclosure. As described below, a particular implementation may omit some or all illustrated features, and may not require some illustrated features to implement all embodiments. In some examples, UE 106 (FIG. 1) may be configured to carry out process 500. In some examples, any suitable apparatus or means for carrying out the functions or algorithm described below may carry out process 500.

In the example of FIG. 5, UE 106 may store a plurality of queues (502). For instance, with respect to FIG. 3, computer-readable storage media 306 may store queues 354. Additionally, UE 106 may obtain PDCP packets for transmission on a network (504). The PDCP packets are assigned to a data radio bearer. For instance, UE 106 may generate the PDCP packets by encapsulating data received from another level of a protocol stack into the PDCP packets with PDCP headers.

UE 106 may assign the PDCP packets to the plurality of queues (506). For instance, UE 106 may assign the low-latency PDCP packets to a first queue of the plurality of queues, assign the high-priority PDCP packets to a second queue of the plurality of queues, and assign the normal priority PDCP packets to a third queue of the plurality of queues.

A radio of UE 106 (e.g., radio 310) may transmit the PDCP packets on the data radio bearer according to positions of the PDCP packets in the plurality of queues (508).

FIG. 6 is a flow chart illustrating an exemplary process 600 of network node 108 for wireless communication in accordance with some aspects of the present disclosure. In the example of FIG. 6, a radio (e.g., radio 310) of network node 108 receives PDCP packets from UE 106 (602). The PDCP packets are associated with a first layer of a protocol stack. For example, the PDCP packets may be associated with PDCP layer 205 or PDCP layer 255 (FIG. 2). The PDCP packets include PDCP headers that include queue markers. The queue markers indicate which queues, of a plurality of queues (e.g., queues 354), to which UE 106 assigned the PDCP packets for transmission.

Network node 108 may determine an updated order of the PDCP packets based on the queue markers (604). The updated order of the PDCP packets is different from an order in which the network node received the PDCP packets. For example, network node 108 may reorder the PDCP packets such that the PDCP packets have the orders they had when in the queues. To determine the updated order of the PDCP packets, network node 108 may separate PDCP packets based on their queue markers and then, for each of the queues, use sequence identifiers in each of the PDCP packets to reorder the PDCP packets associated with the queue.

Additionally, in the example of FIG. 6, network node 108 may deliver payloads of the PDCP packets to a second layer of the protocol stack according to the updated order of the PDCP packets (606). In some examples, network node 108 may deliver just the payloads of the PDCP packets to the second layer, e.g., if the second layer is a higher layer than the first layer. For instance, the first layer may be PDCP layer 205/255 and the second layer may be SDAP layer 206 or RRC layer 257. In some examples, network node 108 may deliver the headers and payloads of the PDCP packets to the second layer, e.g., if the second layer is a lower layer than the first layer. For instance, the first layer may be PDCP layer 205/255 and the second layer may be RLC layer 204/254. Reordering the PDCP packets allow network node 108 to deliver the payloads in an order in which they were originally prepared for transmission, as opposed to be intermixed with PDCP packets from other queues. This may reduce the processing requirements and/or complexity of the second layer.

The following is a non-limiting list of clauses describing aspects in accordance with one or more techniques of this disclosure.

Clause 1. A User Equipment (UE) for wireless communication, the UE comprising: one or more computer-readable storage media configured to store a plurality of queues; a radio; one or more processors coupled to the radio and the one or more computer-readable storage media, the one or more processors configured to cause the UE to: obtain Packet Data Convergence Protocol (PDCP) packets for transmission on a network, wherein the PDCP packets are assigned to a data radio bearer; assign the PDCP packets to the plurality of queues; and transmit, via the radio, the PDCP packets on the data radio bearer according to positions of the PDCP packets in the plurality of queues.

Clause 2. The UE of clause 1, wherein the PDCP packets include low-latency PDCP packets, high-priority PDCP packets, and normal priority PDCP packets, and the one or more processors are configured to cause the UE to: assign the low-latency PDCP packets to a first queue of the plurality of queues; assign the high-priority PDCP packets to a second queue of the plurality of queues; and assign the normal priority PDCP packets to a third queue of the plurality of queues.

Clause 3. The UE of clause 2, wherein the one or more processors are further configured to cause the UE to: based on a latency of the low-latency PDCP packets being greater than a first latency threshold, mark the low-latency PDCP packets with Explicit Congestion Notification (ECN) data points; and based on a latency of the normal priority PDCP packets being greater than a second latency threshold, mark the normal priority PDCP packets with the ECN data points, wherein the first latency threshold is lower than the second latency threshold.

Clause 4. The UE of any of clauses 1-3, wherein the one or more processors are further configured to cause the UE to implement different discard policies for different queues of the plurality of queues.

Clause 5. The UE of any of clauses 1-4, wherein the one or more processors are further configured to cause the UE to include queue markers in PDCP headers of the PDCP packets, wherein the queue markers indicate which of the queues the PDCP packets were assigned to.

Clause 6. The UE of any of clauses 1-5, wherein the one or more processors are configured to cause the UE to receive, via the radio, from the network, configuration data indicating types of traffic to assign to different queues in the plurality of queues.

Clause 7. The UE of any of clauses 1-6, wherein the one or more processors are configured to cause the UE to transmit, via the radio, UE capability data to the network, the UE capability data indicating one or more of: a quantity of queues in the plurality of queues, types of queues in the plurality of queues, a quantity of packets in each of the queues, or how long the packets have been in the queues.

Clause 8. The UE of clause 7, wherein: the one or more processors are configured to cause the UE to receive, via the radio, from a network entity, queue configuration data, wherein the queue configuration data is based on the UE capability data, and the one or more processors are configured to cause the UE to configure the plurality of queues based on the queue configuration data.

Clause 9. The UE of any of clauses 1-8, wherein the one or more processors are configured to cause the UE to implement, for each queue of the plurality of queues, a queue management process for the queue, wherein the queue management process for the queue manages one or more of: a discard timer for the queue, a prioritization of PDCP packets in the queue, reporting of one or more of buffer status reporting or delay status reporting associated with the queue, and a scheduling request identifier (SR ID) associated with the queue.

Clause 10. The UE of any of clauses 1-9, wherein the one or more processors are configured to cause the UE to implement, for each queue of the plurality of queues, a queue management process for the queue, wherein the queue management process for the queue manages one or more of: (i) one or more Media Access Control (MAC) parameters or (ii) one or more Radio Link Control parameters.

Clause 11. A method for wireless communication, the method comprising: storing, by a User Equipment (UE), a plurality of queues; obtaining, by the UE, Packet Data Convergence Protocol (PDCP) packets for transmission on a network, wherein the PDCP packets are assigned to a data radio bearer; assigning, by the UE, the PDCP packets to the plurality of queues; and transmitting, by the UE, the PDCP packets on the data radio bearer according to positions of the PDCP packets in the plurality of queues.

Clause 12. The method of clause 11, wherein the PDCP packets include low-latency PDCP packets, high-priority PDCP packets, and normal priority PDCP packets, and assigning the PDCP packets comprises: assigning the low-latency PDCP packets to a first queue of the plurality of queues; assigning the high-priority PDCP packets to a second queue of the plurality of queues; and assigning the normal priority PDCP packets to a third queue of the plurality of queues.

Clause 13. The method of clause 12, further comprising: based on a latency of the low-latency PDCP packets being greater than a first latency threshold, marking, by the UE, the low-latency PDCP packets with Explicit Congestion Notification (ECN) data points; and based on a latency of the normal priority PDCP packets being greater than a second latency threshold, marking, by the UE, the normal priority PDCP packets with the ECN data points, wherein the first latency threshold is lower than the second latency threshold.

Clause 14. The method of any of clauses 11-13, wherein implementing, by the UE, different discard policies for different queues of the plurality of queues.

Clause 15. The method of any of clauses 11-14, further comprising including, by the UE, queue markers in PDCP headers of the PDCP packets, wherein the queue markers indicate which of the queues the PDCP packets were assigned to.

Clause 16. The method of any of clauses 11-15, further comprising receiving, by a radio of the UE, from the network, configuration data indicating types of traffic to assign to different queues in the plurality of queues.

Clause 17. The method of any of clauses 11-16, further comprising transmitting, by a radio of the UE, UE capability data to the network, the UE capability data indicating one or more of: a quantity of queues in the plurality of queues or types of queues in the plurality of queues, a quantity of packets in each of the queues, or how long the packets have been in the queues.

Clause 18. The method of clause 17, further comprising: receiving, by the radio of the UE, from a network entity, queue configuration data, wherein the queue configuration data is based on the UE capability data, and configuring, by the UE, the plurality of queues based on the queue configuration data.

Clause 19. The method of any of clauses 11-18, further comprising implementing, by the UE, for each queue of the plurality of queues, a queue management process for the queue, wherein the queue management process for the queue manages one or more of: a discard timer for the queue, a prioritization of PDCP packets in the queue, reporting of one or more of buffer status reporting or delay status reporting associated with the queue, and a scheduling request identifier (SR ID) associated with the queue.

Clause 20. The method of any of clauses 11-19, further comprising implementing, for each queue of the plurality of queues, a queue management process for the queue, wherein the queue management process for the queue manages one or more of: (i) one or More Media Access Control (MAC) parameters or (ii) one or More Radio Link Control parameters.

Clause 21. A network node comprising: a radio configured to receive PDCP packets from a User Equipment (UE), wherein: the PDCP packets are associated with a first layer of a protocol stack, the PDCP packets include PDCP headers that include queue markers, and the queue markers indicate which queues, of a plurality of queues, to which the UE assigned the PDCP packets for transmission; and one or more processors coupled to the radio, the one or more processors configured to cause the network node to: determine an updated order of the PDCP packets based on the queue markers, wherein the updated order of the PDCP packets is different from an order in which the network node received the PDCP packets; and deliver payloads of the PDCP packets to a second layer of the protocol stack according to the updated order of the PDCP packets.

Clause 22. A method for wireless communication, the method comprising: receiving, by a radio of a network node, Packet Data Convergence Protocol (PDCP) packets from a User Equipment (UE), wherein: the PDCP packets are associated with a first layer of a protocol stack, the PDCP packets include PDCP headers that include queue markers, and the queue markers indicate which queues, of a plurality of queues, to which the UE assigned the PDCP packets for transmission; and determining, by one or more processors of the network node, an updated order of the PDCP packets based on the queue markers, wherein the updated order of the PDCP packets is different from an order in which the network node received the PDCP packets; and delivering, by the one or more processors, payloads of the PDCP packets to a second layer of the protocol stack according to the updated order of the PDCP packets.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-6 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-6 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; a, b and c; and so on. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A User Equipment (UE) for wireless communication, the UE comprising:
one or more computer-readable storage media configured to store a plurality of queues;
a radio;
one or more processors coupled to the radio and the one or more computer-readable storage media, the one or more processors configured to cause the UE to:
obtain Packet Data Convergence Protocol (PDCP) packets for transmission on a network, wherein the PDCP packets are assigned to a data radio bearer;
assign the PDCP packets to the plurality of queues; and
transmit, via the radio, the PDCP packets on the data radio bearer according to positions of the PDCP packets in the plurality of queues.

2. The UE of claim 1, wherein the PDCP packets include low-latency PDCP packets, high-priority PDCP packets, and normal priority PDCP packets, and the one or more processors are configured to cause the UE to:
assign the low-latency PDCP packets to a first queue of the plurality of queues;
assign the high-priority PDCP packets to a second queue of the plurality of queues; and
assign the normal priority PDCP packets to a third queue of the plurality of queues.

3. The UE of claim 2, wherein the one or more processors are further configured to cause the UE to:
based on a latency of the low-latency PDCP packets being greater than a first latency threshold, mark the low-latency PDCP packets with Explicit Congestion Notification (ECN) data points; and
based on a latency of the normal priority PDCP packets being greater than a second latency threshold, mark the normal priority PDCP packets with the ECN data points, wherein the first latency threshold is lower than the second latency threshold.

4. The UE of claim 1, wherein the one or more processors are further configured to cause the UE to implement different discard policies for different queues of the plurality of queues.

5. The UE of claim 1, wherein the one or more processors are further configured to cause the UE to include queue markers in PDCP headers of the PDCP packets, wherein the queue markers indicate which of the queues the PDCP packets were assigned to.

6. The UE of claim 1, wherein the one or more processors are configured to cause the UE to receive, via the radio, from the network, configuration data indicating types of traffic to assign to different queues in the plurality of queues.

7. The UE of claim 1, wherein the one or more processors are configured to cause the UE to transmit, via the radio, UE capability data to the network, the UE capability data indicating one or more of: a quantity of queues in the plurality of queues, types of queues in the plurality of queues, a quantity of packets in each of the queues, or how long the packets have been in the queues.

8. The UE of claim 7, wherein:
the one or more processors are configured to cause the UE to receive, via the radio, from a network entity, queue configuration data, wherein the queue configuration data is based on the UE capability data, and
the one or more processors are configured to cause the UE to configure the plurality of queues based on the queue configuration data.

9. The UE of claim 1, wherein the one or more processors are configured to cause the UE to implement, for each queue of the plurality of queues, a queue management process for the queue, wherein the queue management process for the queue manages one or more of: a discard timer for the queue, a prioritization of PDCP packets in the queue, reporting of one or more of buffer status reporting or delay status reporting associated with the queue, and a scheduling request identifier (SR ID) associated with the queue.

10. The UE of claim 1, wherein the one or more processors are configured to cause the UE to implement, for each queue of the plurality of queues, a queue management process for the queue, wherein the queue management process for the queue manages one or more of: (i) one or more Media Access Control (MAC) parameters or (ii) one or more Radio Link Control parameters.

11. A method for wireless communication, the method comprising:
storing, by a User Equipment (UE), a plurality of queues;
obtaining, by the UE, Packet Data Convergence Protocol (PDCP) packets for transmission on a network, wherein the PDCP packets are assigned to a data radio bearer;
assigning, by the UE, the PDCP packets to the plurality of queues; and
transmitting, by the UE, the PDCP packets on the data radio bearer according to positions of the PDCP packets in the plurality of queues.

12. The method of claim 11, wherein the PDCP packets include low-latency PDCP packets, high-priority PDCP packets, and normal priority PDCP packets, and assigning the PDCP packets comprises:
assigning the low-latency PDCP packets to a first queue of the plurality of queues;
assigning the high-priority PDCP packets to a second queue of the plurality of queues; and
assigning the normal priority PDCP packets to a third queue of the plurality of queues.

13. The method of claim 12, further comprising:
based on a latency of the low-latency PDCP packets being greater than a first latency threshold, marking, by the UE, the low-latency PDCP packets with Explicit Congestion Notification (ECN) data points; and
based on a latency of the normal priority PDCP packets being greater than a second latency threshold, marking, by the UE, the normal priority PDCP packets with the ECN data points, wherein the first latency threshold is lower than the second latency threshold.

14. The method of claim 11, wherein implementing, by the UE, different discard policies for different queues of the plurality of queues.

15. The method of claim 11, further comprising including, by the UE, queue markers in PDCP headers of the PDCP packets, wherein the queue markers indicate which of the queues the PDCP packets were assigned to.

16. The method of claim 11, further comprising receiving, by a radio of the UE, from the network, configuration data indicating types of traffic to assign to different queues in the plurality of queues.

17. The method of claim 11, further comprising:
transmitting, by a radio of the UE, UE capability data to the network, the UE capability data indicating one or more of: a quantity of queues in the plurality of queues or types of queues in the plurality of queues, a quantity of packets in each of the queues, or how long the packets have been in the queues;
receiving, by the radio of the UE, from a network entity, queue configuration data, wherein the queue configuration data is based on the UE capability data; and
configuring, by the UE, the plurality of queues based on the queue configuration data.

18. The method of claim 11, further comprising implementing, by the UE, for each queue of the plurality of queues, a queue management process for the queue, wherein the queue management process for the queue manages one or more of: a discard timer for the queue, a prioritization of PDCP packets in the queue, reporting of one or more of buffer status reporting or delay status reporting associated with the queue, and a scheduling request identifier (SR ID) associated with the queue.

19. The method of claim 11, further comprising implementing, for each queue of the plurality of queues, a queue management process for the queue, wherein the queue management process for the queue manages one or more of: (i) one or more Media Access Control (MAC) parameters or (ii) one or more Radio Link Control parameters.

20. A network node comprising:
a radio configured to receive PDCP packets from a User Equipment (UE), wherein:
the PDCP packets are associated with a first layer of a protocol stack,
the PDCP packets include PDCP headers that include queue markers, and
the queue markers indicate which queues, of a plurality of queues, to which the UE assigned the PDCP packets for transmission; and
one or more processors coupled to the radio, the one or more processors configured to cause the network node to:
determine an updated order of the PDCP packets based on the queue markers, wherein the updated order of the PDCP packets is different from an order in which the network node received the PDCP packets; and
deliver payloads of the PDCP packets to a second layer of the protocol stack according to the updated order of the PDCP packets.
